(19) United States
(12) Patent Application Publication
(10) Pub. No.: US 2025/0256808 A1
(43) Pub. Date: Aug. 14, 2025

(54) ROUTING PULLEY TO LIMIT VIRTUAL CHAIN GROWTH IN GEARED REAR SUSPENSION BICYCLES

(71) Applicant: Priority Outdoor Products, LLC, New York, NY (US)

(72) Inventors: Fabien Gaston Lemasson, Lignieres-Orgeres (FR); Michael Schwartz, Douglaston, NY (US)

(21) Appl. No.: 18/755,497

(22) Filed: Jun. 26, 2024

Related U.S. Application Data
(63) Continuation-in-part of application No. 18/439,787, filed on Feb. 13, 2024.

(51) Int. Cl. B62M 9/16; B62K 25/04; B62M 9/125

(52) U.S. Cl. CPC B62M 9/16; B62K 25/04; B62M 9/125

(57) ABSTRACT

A rear suspension chain drive bicycle having a routing pulley to route an untensioned portion of a chain drive to a tensioned portion of the chain drive to reduce chain growth experienced thereby. The use of the routing pulley to reduce chain growth enable a derailleur to accommodate addition vertical rear wheel travel. The routing pulley can be used in high pivot and low pivot rear suspension bicycles. High pivot bicycles have a rear suspension pivot point sufficiently above a crank axis (front chainring) to provide predominately rearward axle path and require an idler pulley to route the chain drive. The routing pulley is located above the front chain ring and for the high pivot bicycle is located close to the idler pulley.

### PRIORITY

This application is continuation in part (CIP) of, and claims the benefit under 35 U.S.C. § 120, application Ser. No. 18/439,787, filed on Feb. 13, 2024, entitled “Tensioner Device to Account for Virtual Chain Growth in Internally Geared High Pivot Point Rear Suspension Bicycles”, and having Fabien Gaston Lemasson and Michael Schwartz as inventors. Application Ser. No. 18/439,787 is incorporated herein by reference in its entirety.

### BACKGROUND

FIG. 1 illustrates a line diagram of an example chain driven rear suspension bicycle 100. The bicycle 100 includes a frame made up of a front triangle 110 and a swingarm (rear triangle) 130. The front triangle 110 includes a seat tube 112, a top tube 114 and a down tube 116. The top tube 114 and the down tube 116 are connected to a head tube 118 that connects to handlebars (not illustrated) and a front fork 120 that is used to secure a front wheel (not illustrated) at a front wheel axle (axis) 122. The seat tube 112 and the down tube 116 are connected to each other via a bottom bracket shell (not separately illustrated, just shown as point of intersection between seat tube 112 and the down tube 116 for ease of illustration). The swingarm 130 may include a seatstay 132 and a chainstay 134, or a combined chain and seatstay 134 alone in case of a mono-arm bicycle. The seatstay 132 and the chainstay 134 meet to secure a rear wheel (not illustrated) at a rear wheel axle (axis) 136. For a mono-arm bicycle, simply the combined chain and seatstay 134 would secure the rear wheel.

The swingarm 130 may be connected to the front triangle 100 via a shock absorber or other linkages that are not illustrated for simplicity. The bicycle 100 also includes a rear suspension axis 140 (main pivot point). It should be noted that the rear suspension axis 140 could have a floating or virtual pivot, which may or may not coincide with a physical point on the bicycle frame, where the axis is found at an instant center that varies depending on the rear suspension position. In this case, the rear wheel axle 136 may be connected to either the seatstay 132 or the chainstay 134. A floating pivot is not illustrated for ease of illustration and simplicity of explaining the basic components.

The bicycle 100 also includes a drive train 150 for providing movement thereof. The drivetrain 150 consists of a chain drive 152, a rear cassette 154 and a front chain ring 156. The rear cassette 154 is located on the rear wheel centered around the rear wheel axle 136. The rear cassette 154 includes a plurality of different sized cogs 158 (to achieve different gear ratios) for receiving and routing the chain drive 152. The front chain ring 156 is located on the bottom bracket shell. The chain drive 152 routes around the appropriate cog 158 of the rear cassette 154 and the front chainring 156. An upper portion of the chain drive 152U moves forward from the rear cassette 154 to the front chainring 156 and a lower portion of the chain drive 152L moves rearward from the front chainring 156 to the rear cassette 154. The bottom bracket shell enables a crank set and pedals (not illustrated) to be connected thereto and create a crank axis 160 (simply shown as point of intersection between seat tube 112 and the down tube 116 for ease of illustration). The crank axis 160 enables a user to pedal the bicycle 100 in order to engage the drive train 150 and move the bicycle 100. The pedaling causes the rotation of the front chain ring 156 which will in turn rotate the chain drive 152 and the appropriate cog 158 of the rear cassette 154 and the rotation of the cog 158 causes rotation of the rear wheel. If the bicycle 100 is an electric bicycle, it will include an electric motor (not illustrated) to provide, or assist with, the movement of the bicycle 100.

The amount of the chain drive 152 required to route around a larger cog 158 of the rear cassette 154 and the front chainring 156 is more than is required to route the chain drive 152 around a smaller cog 158. The extra chain drive 152 required is known as virtual chain growth. To account for the chain growth, a derailleur 162 is utilized to take up the slack therein based on the cog 158 that the chain drive 152 is routed around. The derailleur 162 is a rotating member 164 onto which two idler pulleys 166 are mounted. The derailleur 162 is secured to the swingarm 130 in close proximity to the rear cassette 154 and is spring loaded to rotate the rotating member 164 and the idler pulleys 166 based on the rear cog size 158. This allows for virtual chain growth that results from shifting the chain to different sized cogs 158 on the rear cassette 154.

In addition to the cog 158 utilized affecting chain growth, a vertical distance that the rear wheel axis 136 travels with respect to its resting position (known as vertical rear wheel travel) may result in chain growth. That is, as the rear wheel axis 136 moves upward along a path defined by the rear suspension axis 140, if the distance between the rear wheel axis 136 and the crank axis 160 increases, it will result in chain growth. As with most mechanical vehicle suspension systems, a bicycle 100 with rear suspension will be designed such that the swingarm 130, as it moves throughout its range of vertical rear wheel travel, will act upon a shock absorber resulting in a displacement of a spring. This spring displacement (suspension compression) absorbs shock impulses to the bicycle 100 by converting kinetic energy into potential energy.

FIG. 2 illustrates a simple graph showing that chain growth increases nearly linearly as vertical rear wheel travel increases in the case of a single pivot point bicycle. The graph does not apply in the case of a virtual or floating pivot bicycles. The amount of chain growth will depend on the frame and suspension geometry and kinematics, as well as the front and rear sprocket size combination.

FIGS. 3A-D illustrate simplified line diagrams of the example chain driven rear suspension bicycle 100 of FIG. 1 in different gear ratios and rear suspension positions. FIG. 3A illustrates the bicycle 100 in a gear associated with the chain drive 152 routing around a larger cog of the rear cassette (not illustrated or identified in simplified drawing). The derailleur 162 provides an angle 310 in the routing of the chain drive 152 (driveline angle 310) to provide the appropriate tension thereto based on the gear. FIG. 3B illustrates the bicycle 100 in the same gear as FIG. 3A but with the bicycle 100 experiencing a vertical rear wheel travel 320. The vertical rear wheel travel 320 accounts for additional chain growth so that the driveline angle 330 is increased (angle 330 is greater than angle 310) to provide the appropriate tension thereto based on the gear. The increased driveline angle is the result of the rear wheel axle 136 moving away from the crank axis 160 as the vertical rear wheel travel 320 increases and the fixed length of the chain drive 152.

FIG. 3C illustrates the bicycle 100 in a gear associated with the chain drive 152 routing around a smaller cog of the rear cassette (not illustrated or identified in simplified drawing). The derailleur 162 provides a driveline angle 340 in the routing of the chain drive 152 to provide the appropriate tension thereto based on the gear. Note the angle 340 is smaller than the angle 310 since the chain drive 152 has a lesser distance to wrap around the smaller cog of the rear cassette. FIG. 3D illustrates the bicycle 100 in the same gear as FIG. 3C but with the bicycle 100 experiencing a vertical rear wheel travel 350. The vertical rear wheel travel accounts for additional chain growth so that the driveline angle 360 is increased (angle 360 is greater than angle 340). The increased driveline angle is the result of the rear wheel axle 136 moving away from the crank axis 160.

FIGS. 3A-D clearly illustrate the derailleur 162 fulfills the dual purpose of varying external gear ratio with a cassette as well as accommodating chain growth based on vertical rear wheel travel.

As chain drives 152 are inelastic, the maximum vertical rear wheel travel will be restricted by the amount of chain growth that can be accommodated by a derailleur 162. If the amount of chain growth surpasses what the derailleur 162 can handle, the vertical wheel travel will be limited and/or damage or failure to drivetrain 150 components of the bicycle 100 such as the chain drive 152 or the derailleur 162 will occur. Reducing the amount of chain growth would thus allow a derailleur 162 to compensate for more chain growth and thus allow for suspension designs with more vertical rear wheel travel. As such, solutions to reduce chain growth are required.

### BRIEF DESCRIPTION OF DRAWINGS

The features and advantages of the various embodiments will become apparent from the following detailed description in which:

FIG. 1 illustrates a line diagram of an example chain driven rear suspension bicycle.

FIG. 2 illustrates a simple graph showing that chain growth increases nearly linearly as vertical rear wheel travel increases for single pivot point bicycles.

FIGS. 3A-D illustrate simplified line diagrams of example chain driven rear suspension bicycle of FIG. 1 in different gear ratios and rear suspension positions.

FIG. 4 illustrates a graph showing how X location (backwards and forwards) and Y location (up and down) of the suspension pivot affect chain growth.

FIGS. 5A-B illustrate simple line diagrams of an example high pivot rear suspension bicycle in same gear but different suspension positions, according to one embodiment.

FIG. 6 illustrates a line diagram of an example chain driven high pivot point rear suspension bicycle having a routing pulley to reduce chain growth, according to one embodiment.

FIGS. 7A-B illustrate simple line diagrams of the example high pivot rear suspension bicycle of FIG. 6 in same gear but different suspension positions, according to one embodiment.

FIGS. 8A-C illustrate various different detailed views of a portion of a bicycle of FIG. 6 showing the location of the idler pulley and the routing pulley, according to one embodiment.

FIGS. 9A-B illustrate simple line diagrams of an example low pivot rear suspension bicycle in same gear but different suspension positions, according to one embodiment.

FIG. 10 illustrates a line diagram of an example chain driven low pivot point rear suspension bicycle having a routing pulley to reduce chain growth, according to one embodiment.

FIGS. 11A-B illustrate simple line diagrams of the example low pivot rear suspension bicycle of FIG. 10 in same gear but different suspension positions, according to one embodiment.

### DETAILED DESCRIPTION

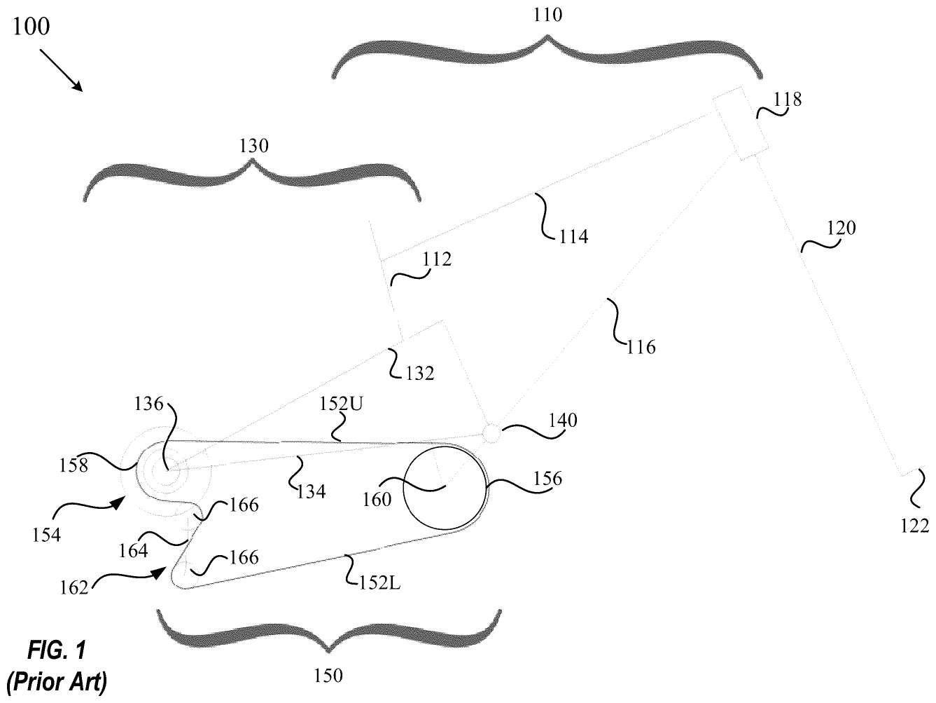

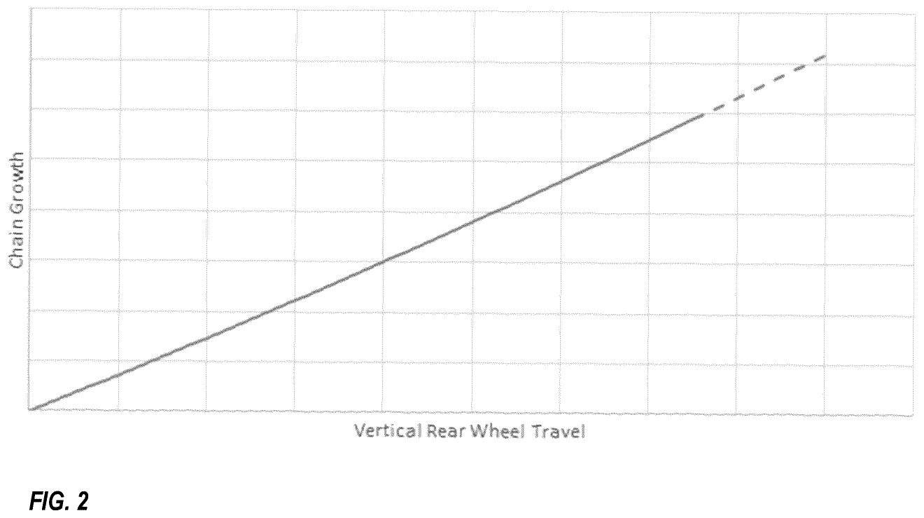

As illustrated in FIG. 1, most common rear suspension designs have a rear suspension axis (pivot point) 140 near the crank axis 160 and the front chainring 156. These rear suspension designs provide an axle path that rotates in a circular direction generally towards the front of the bicycle. This generally forward rotation is to the detriment of suspension performance, as the general force vector experienced by a rear wheel when it impacts a road obstacle is in a generally rearward direction. By moving the rear suspension pivot point higher (e.g., further above the crank axis 160 and the front chainring 156), the axle path of a bicycle becomes more rearward, better matching the direction of the force vector imparted by a rear wheel impact. A high rear suspension pivot point bicycle is one where the rear suspension pivot point is located high enough that an idler pulley is required to route the chain 152 coming from the rear cassette 154 to the front chainring 156. Bicycles having high rear suspension pivot points are becoming popular as they provide improved suspension control and a smoother ride in rough terrain.

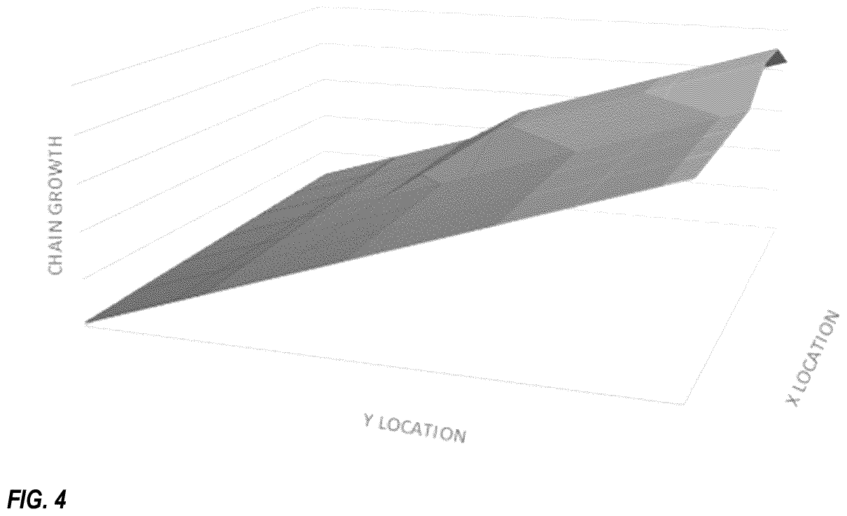

FIG. 4 illustrates a graph showing how X location (backwards and forwards) and Y location (up and down) of the suspension pivot affect chain growth. As can be seen, the Y location has more impact. The amount of chain growth will depend on the frame and suspension geometry, as well as the front, idler and rear sprocket size combination. As such, high rear suspension pivot points increase the chain growth issue when compared to most other suspension designs.

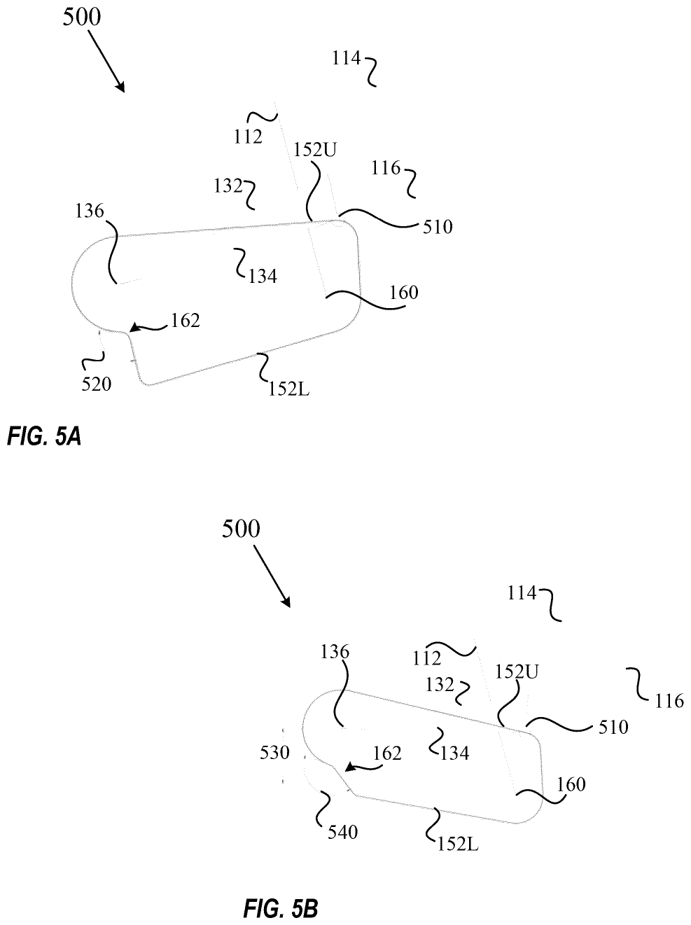

FIGS. 5A-B illustrate simple line diagrams of an example high pivot rear suspension bicycle 500 in a certain gear (e.g., chain engaged on largest cog). The bicycle 500 includes a rear suspension axis 510 (main pivot point) that is higher than the rear suspension axis 140 of bicycle 100. The axle path of the bicycle 500 is accordingly substantially rearward. An idler pulley (not illustrated) is located in close proximity to the high rear suspension axis 510. The chain drive 152 is routed around a certain cog of the rear cassette (not illustrated or identified in simplified drawing) centered around the rear wheel axle 136, the idler pulley located in close proximity to the high rear suspension axis 510, the front chainring (not illustrated) centered around the crank axis 160 and the derailleur 162. The actual components of the derailleur 162 are not illustrated for simplicity. Rather, they are simply illustrated as adjusting the path that the chain drive 152 travels.

FIG. 5A illustrates the bicycle 500 prior to any vertical rear wheel travel having a driveline angle 520 to provide appropriate tension to account for the gear selected (e.g., chain engaged on largest cog). FIG. 5B illustrates the bicycle 500 experiencing vertical rear wheel travel 530 and having a driveline angle 540 to provide appropriate tension to account for the gear selected and the vertical rear wheel travel 530. The driveline angle 540 is greater than the driveline angle 520 as the vertical rear wheel travel 530 accounts for additional chain growth. The more vertical rear wheel travel that the bicycle 500 experiences, the more that the driveline angle increases.

The high pivot rear suspension bicycle 500 increases the chain growth that is experienced for vertical rear wheel travel. In addition, bicycles may utilize larger rear cassettes (more cogs) which increases the amount of chain growth. The derailleur 162 may have limits in the increase in the driveline angle that can be obtained and thus the chain growth accounted for. The derailleur cage cannot be extended indefinitely without posing mechanical and ground clearance/obstacle vulnerability issues. Accordingly, there is a maximum vertical rear wheel travel that can be obtained for different cogs (larger the cog the less vertical rear wheel travel and vice versa).

One solution to address the limitations in the amount of chain growth (caused by cog size and vertical rear wheel travel) that the derailleur 162 can handle is to route the untensioned span of the chain 152L toward the tensioned span of the chain 152U so as to be closer to the tensioned span of the chain 152U. A routing pulley could be utilized to route the chain 152 in such a fashion. The use of the routing pulley to route the chain 152 in this fashion would reduce the amount of chain growth throughout the suspension travel. The closer the untensioned portion of chain 152L is routed to the tensioned portion of the chain 152U, the less chain growth that will be experienced for a specific vertical rear wheel travel and the more vertical real wheel travel that the derailleur 162 can handle. The routing pulley could be located in proximity to the high rear suspension axis 510 and the idler pulley.

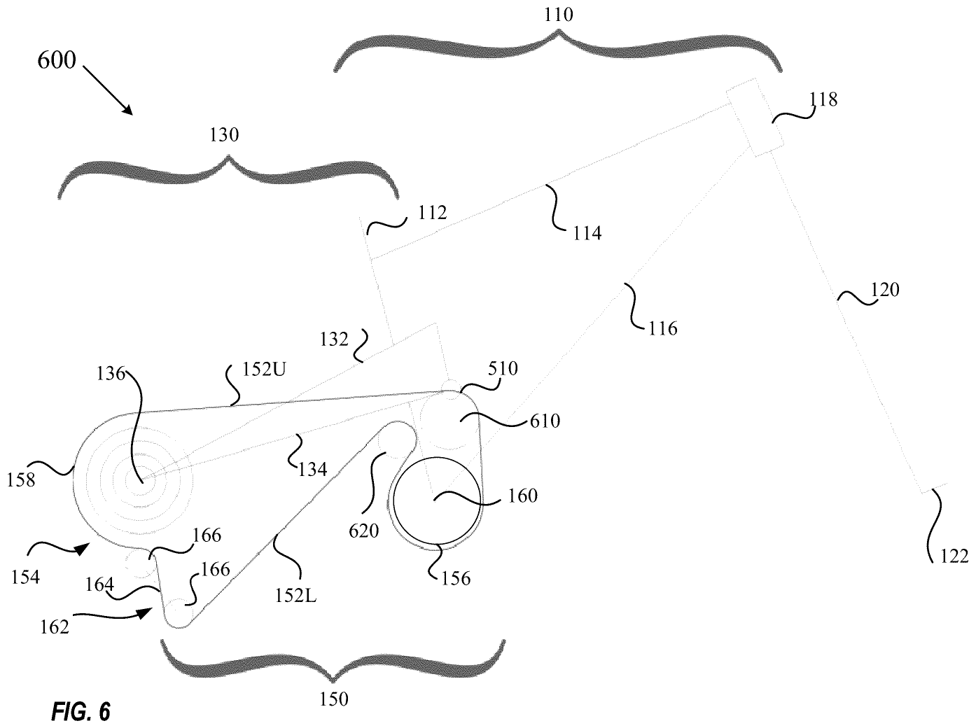

FIG. 6 illustrates a line diagram of an example chain driven high pivot point rear suspension bicycle 600. The bicycle 600 will use the same reference numbers to identify the same components discussed with regard to previous Figures and will not describe them below to avoid redundancy. The idler pulley 610 is located in close proximity to the high rear suspension axis 510. The idler pulley 610 may be mounted to the front triangle 110 (e.g., the seat tube 112). A routing pulley 620 is located above the front chainring 156 and behind the idler pulley 610. The routing pulley 620 may be mounted to the front triangle 110 (e.g., the seat tube 112). The drive train 150 of the bicycle 600 includes the chain drive 152, the rear cassette 154, the idler pulley 610, the front chainring 156, the routing pulley 620 and the derailleur 162.

The chain drive 152 routes around the appropriate cog 158 of the rear cassette 154, the idler pulley 610, the front chainring 156, the routing pulley 620, the derailleur 162 and back to the appropriate cog 158 of the rear cassette 154. The idler pulley 610 routes the upper (tensioned) portion of the chain drive 152U to the front chainring 156 and the routing pulley 620 routes the lower (untensioned) portion of the chain drive 152L towards the idler pulley 610 and the high pivot point 510 (closer to the tensioned chain drive 152U) prior to routing to the derailleur 162. Pedaling causes the rotation of the front chainring 156 which will in turn rotate the chain drive 152 which in turn will rotate the appropriate cog 158 of the rear cassette 154 and the rear wheel.

The use of the routing pulley 620 reduces the amount of chain growth throughout the suspension travel. Accordingly, the chain growth that the derailleur 162 is required to handle based on vertical rear wheel travel is reduced. The derailleur 162 will still adjust the driveline angle based on gear selected (e.g., larger driveline angle for larger cogs). However, the change from an initial driveline angle for no vertical rear wheel travel to a new driveline angle for encountering vertical rear wheel travel will be reduced.

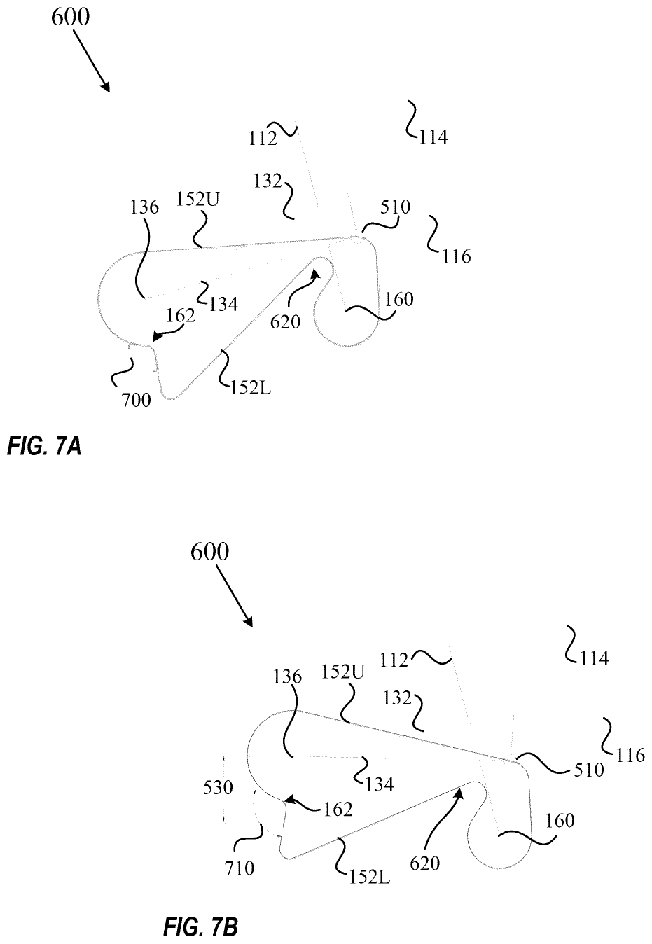

FIGS. 7A-B illustrate simple line diagrams of an example high pivot rear suspension bicycle 600 in the same gear (e.g., chain engaged on largest cog) as the bicycle 500 illustrated in FIGS. 5A-B. The chain 152 is routed around the routing pulley 620 to reduce the chain growth. FIG. 7A illustrates the bicycle 600 prior to any vertical rear wheel travel and the derailleur 162 having a driveline angle 700. FIG. 7B illustrates the bicycle 600 with the same vertical rear wheel travel 530 as FIG. 5B. The derailleur 162 has a driveline angle 710 to account for the chain growth encountered from the vertical rear wheel travel 530. The change between the initial driveline angle 700 associated with no vertical rear wheel travel (FIG. 7A) and the driveline angle 710 associated with the vertical rear wheel travel 530 (FIG. 7B) is substantially less than the change between the initial driveline angle 520 associated with no vertical rear wheel travel (FIG. 5A) and the driveline angle 540 associated with the vertical rear wheel travel 530 (FIG. 5B). The use of the routing pulley 620 reduced the change in the driveline angle required to account for the same vertical rear wheel travel 530.

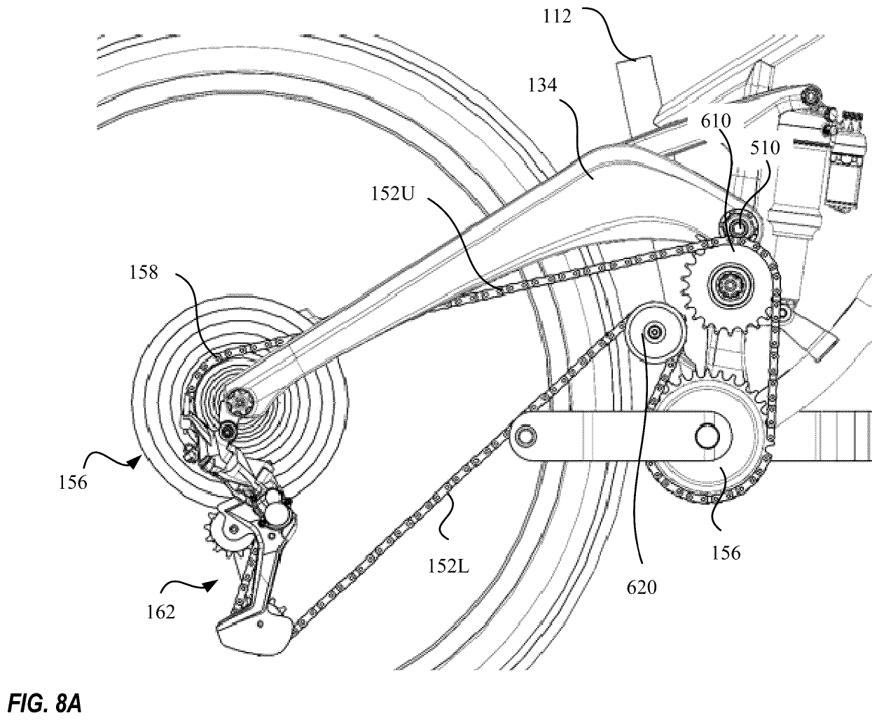

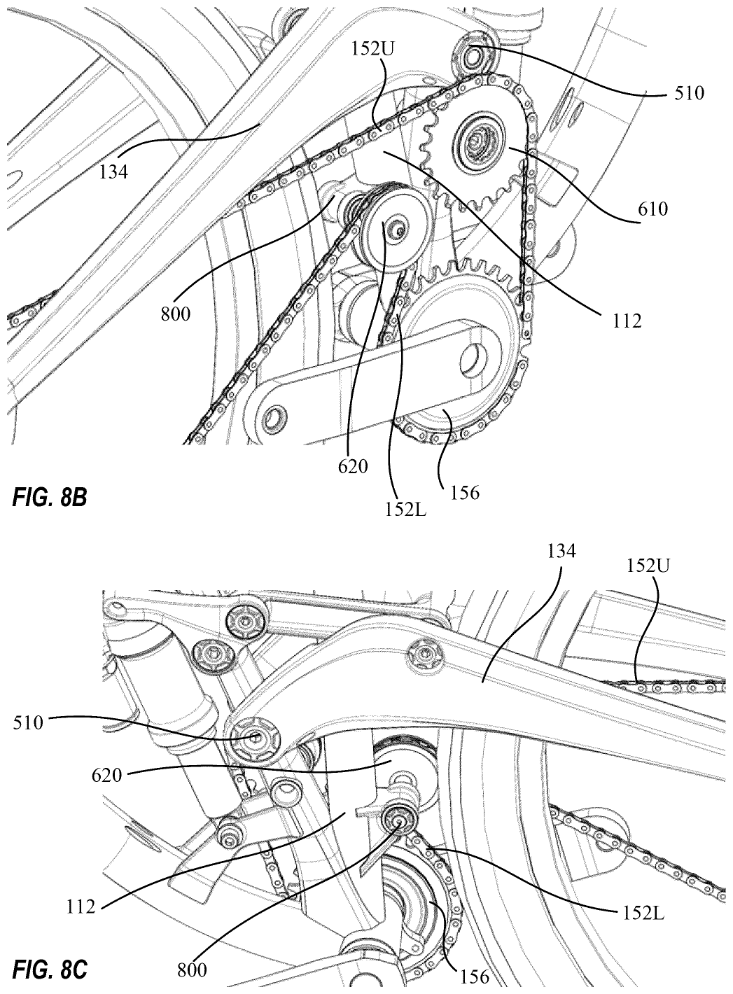

FIGS. 8A-C illustrate various different detailed views of a portion of a bicycle 600 showing the location of the idler pulley 610 and the routing pulley 620. The idler pulley 610 and the routing pulley 620 may be mounted to the front triangle 110. According to one embodiment, a bracket 800 extends from the seat tube 112 and the routing pulley 620 is secured to the bracket 800. As can be seen the idler pulley 610 and the routing pulley 620 are located in proximity to each other and the routing pulley 620 clearly routes the untensioned portion of chain 152L toward the idler pulley 610 and the high pivot point 510 to be closer to the tensioned portion of the chain 152U on its return path to the derailleur 162.

While the increase in chain growth created by low pivot rear suspension bicycles (e.g., bicycle 100) is not as much as the increase in chain growth created by high pivot rear suspension bicycles (e.g., bicycles 500), there still may be practical limits in the amount of chain growth (e.g., cog size, vertical rear wheel travel) that the derailleur 162 can accommodate.

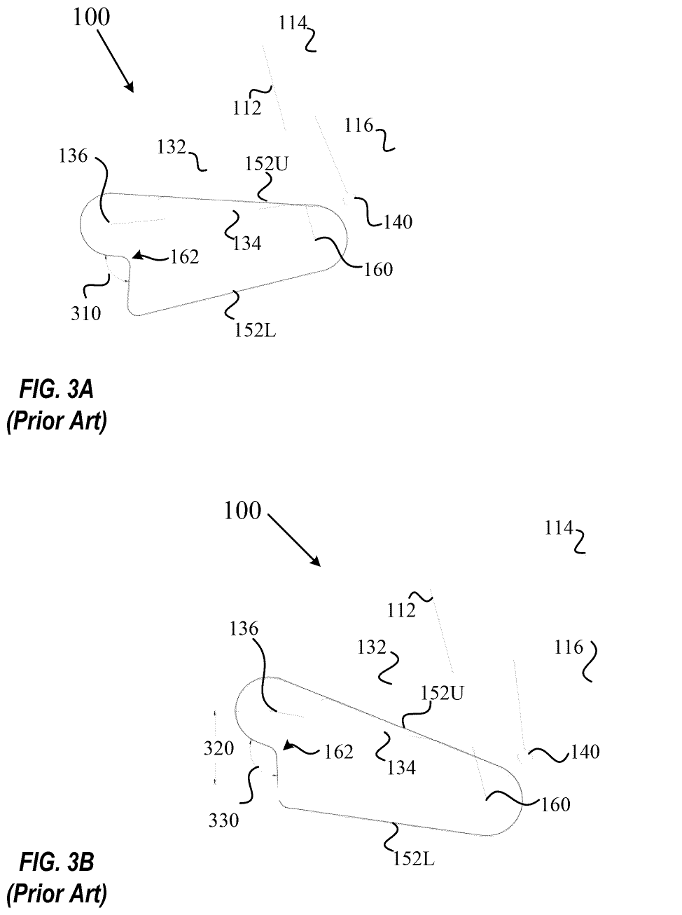

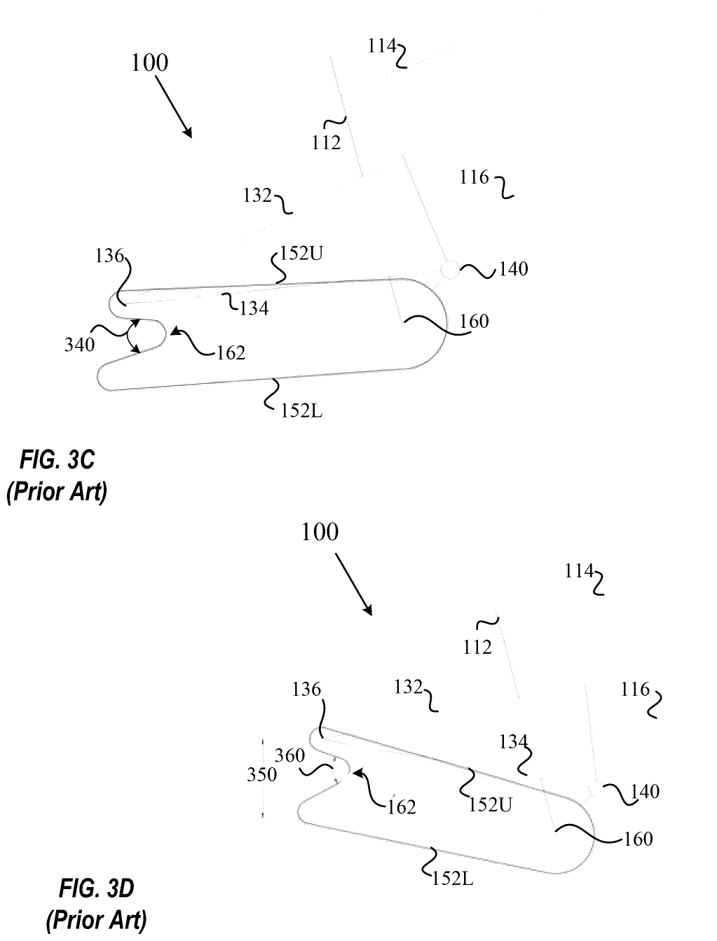

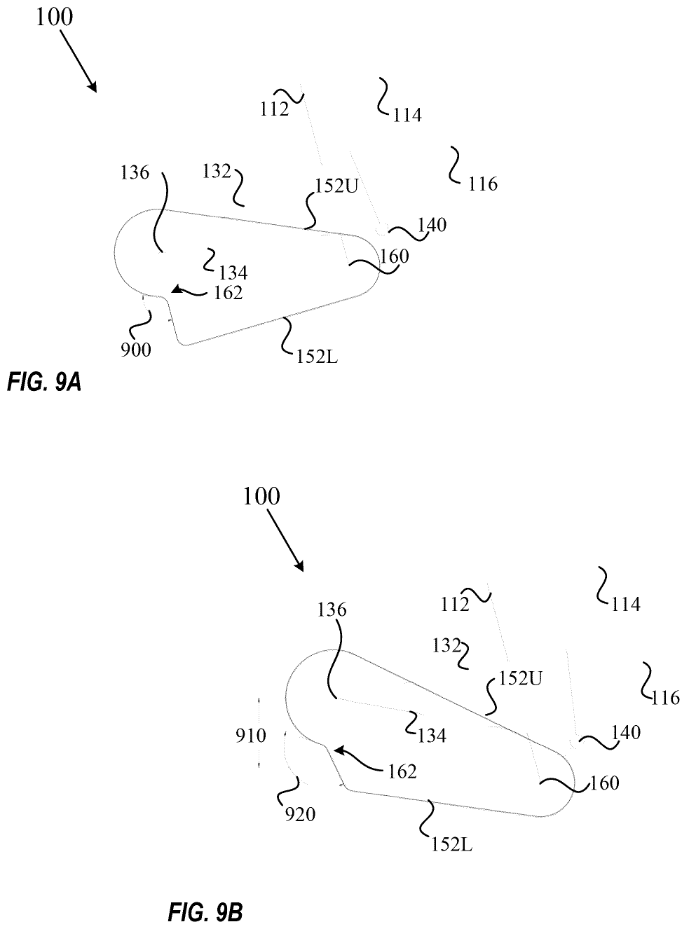

FIGS. 9A-B illustrate simple line diagrams of an example low pivot rear suspension bicycle 100 in a certain gear (e.g., chain engaged on largest cog, larger than illustrated in FIGS. 3A-D) before and after experiencing vertical rear wheel travel. FIG. 9A illustrates the bicycle 100 prior to any vertical rear wheel travel having a driveline angle 900 to account for gear selected. FIG. 9B illustrates the bicycle 100 experiencing vertical rear wheel travel 910 and having a driveline angle 920 to account for the gear selected and the vertical rear wheel travel 910. The driveline angle 920 is greater than the driveline angle 900 as the vertical rear wheel travel 910 accounts for additional chain. The more vertical rear wheel travel that the bicycle 100 experiences, the more that the driveline angle increases. While not illustrated in FIGS. 9A-B, it follows that the larger the cog size of the rear wheel cassette 154 the larger the driveline angle (as was previously illustrated in FIGS. 3A-D).

The use of a routing pulley in conjunction with a derailleur is not limited to use with high pivot rear suspension bicycles. Rather, this configuration could also be utilized for low pivot rear suspension bicycles as well. Such use would reduce the amount of chain growth caused by vertical rear wheel suspension and thus enable the driveline angle required to be reduced. Accordingly, a standard derailleur could provide the driveline angle required for larger sprockets on a cassette to be provided. Alternatively, the derailleur cage length could possibly be reduced, improving ground clearance.

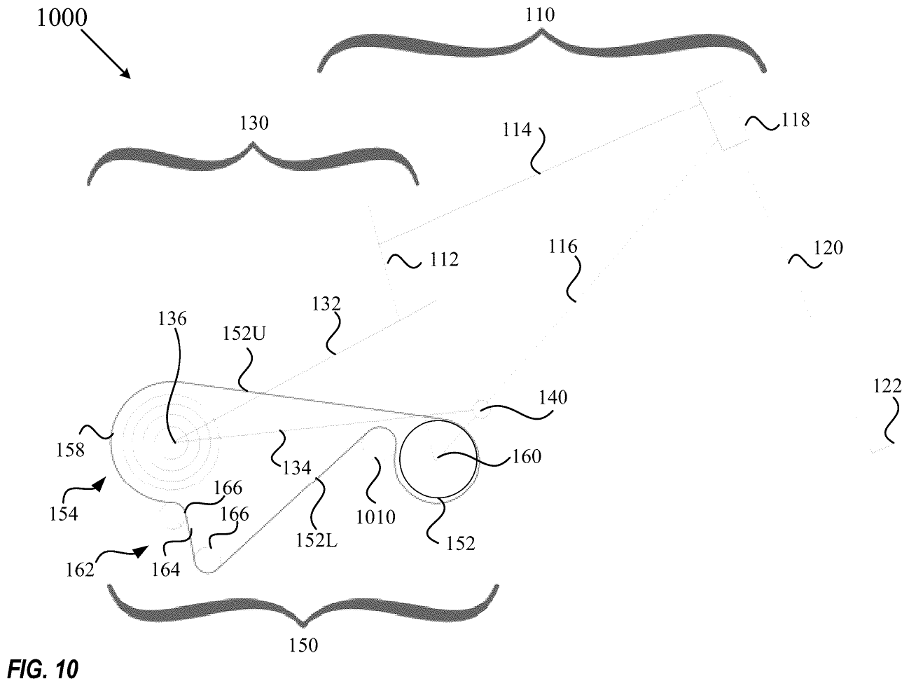

FIG. 10 illustrates a line diagram of an example chain driven low pivot point rear suspension bicycle 1000. The bicycle 1000 will use the same reference numbers to identify the same components discussed with regard to previous Figures and will not describe them below to avoid redundancy. A routing pulley 1010 is located above and behind the front chainring 156 in order to route the untensioned portion of the chain 152L to the tensioned portion of the chain 152U. The routing pulley 1010 may be mounted to the front triangle 110 (e.g., the seat tube 112). The drive train 150 of the bicycle 1000 includes the chain drive 152, the rear cassette 154, the front chainring 156, the routing pulley 1010 and the derailleur 162. The chain drive 152 routes around the appropriate cog 158 of the rear cassette 154, the front chainring 156, the routing pulley 1010, the derailleur 162 and back to the appropriate cog 158 of the rear cassette 154. Pedaling causes the rotation of the front chainring 156 which will in turn rotate the chain drive 152 which in turn will rotate the appropriate cog 158 of the rear cassette 154 and the rear wheel.

The use of the routing pulley 1010 reduces the amount of chain growth throughout the suspension travel. Accordingly, the chain growth that the derailleur 162 is required to handle based on vertical rear wheel travel is reduced. The derailleur 162 will still adjust the driveline angle based on gear selected (e.g., larger driveline angle for larger cogs). However, the change from an initial driveline angle for no vertical rear wheel travel to a new driveline angle for encountering vertical rear wheel travel will be reduced.

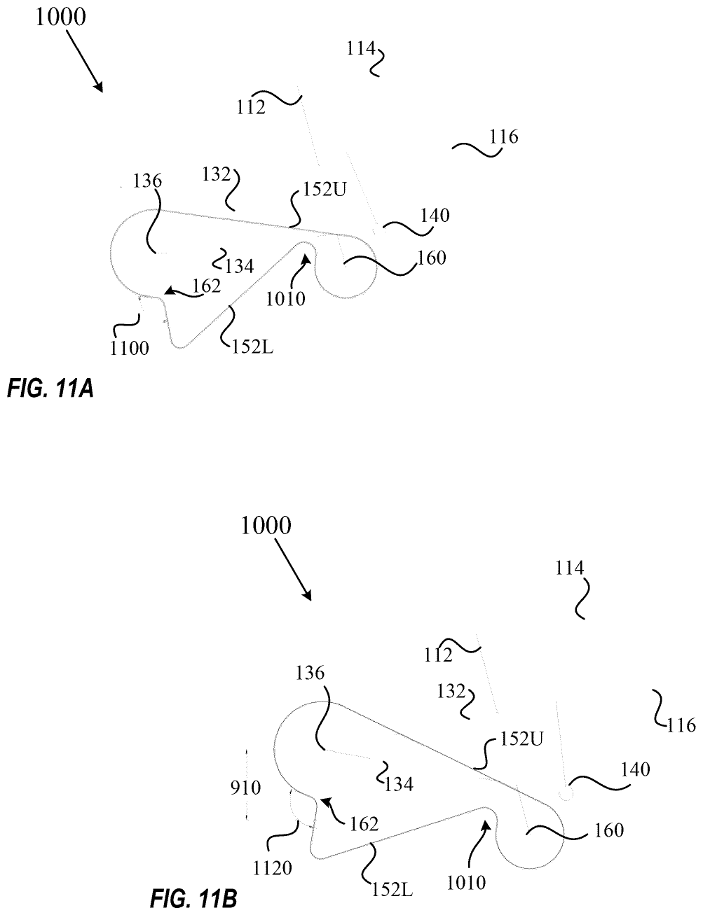

FIGS. 11A-B illustrate simple line diagrams of an example low pivot rear suspension bicycle 1000 in the same gear (e.g., chain engaged on largest cog) as the bicycle 100 illustrated in FIGS. 9A-B. FIG. 11A illustrates the bicycle 1000 in the same gear but utilizing the routing pulley 1010 to route the chain 152 upwards at that point. FIG. 11B illustrates the bicycle 1000 in the same gear and with the same vertical rear wheel travel 910 but utilizing the routing pulley 1010 to route the chain 152 upwards. The change between the initial driveline angle 1100 associated with no vertical rear wheel travel (FIG. 11A) and the driveline angle 1120 associated with the vertical rear wheel travel 910 (FIG. 11B) is substantially less than the change between the initial driveline angle 900 associated with no vertical rear wheel travel (FIG. 9A) and the driveline angle 920 associated with the vertical rear wheel travel 910 (FIG. 9B).

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed is:

1. A high pivot point rear suspension bicycle comprising
a frame including a front triangle and a swingarm;
a rear suspension pivot point between the front triangle and the swingarm, wherein location of the rear suspension pivot point provides a predominantly rearward axle path; and
a drive train including a chain drive, a rear cassette having a plurality of cogs located at a rear wheel axis, an idler pulley located in close proximity to the rear suspension pivot point, a front chainring located at a crank axis, a routing pulley and a derailleur located in proximity to the rear cassette, wherein the chain drive traverses from the rear cassette to the idler pulley, from the idler pulley to the front chainring, from the front chainring to the routing pulley, from the routing pulley to the derailleur, and from the derailleur back to the rear cassette, wherein the derailleur is to provide different driveline angles based on chain growth of the chain drive caused by the cog of the rear cassette selected and vertical rear wheel travel of the bicycle.

2. The bicycle of claim 1, wherein the routing pulley is located in proximity to the idler puller and routes an untensioned portion of the chain drive toward a tensioned portion of the chain drive in order to reduce chain growth in the chain drive.

3. The bicycle of claim 1, wherein the routing pulley is mounted to the front triangle.

4. The bicycle of claim 1, wherein the routing pulley is mounted to a seat tube of the front triangle.

5. The bicycle of claim 4, wherein the seat tube includes a bracket extending therefrom and the routing pulley is mounted to the bracket.

6. The bicycle of claim 1, wherein the idler pulley is mounted to the front triangle.

7. The bicycle of claim 1, wherein the driveline angle provided by the derailleur increases as the chain growth increases.

8. The bicycle of claim 1, wherein the driveline angle provided by the derailleur increases as the vertical rear wheel travel increases.

9. The bicycle of claim 1, wherein the driveline angle provided by the derailleur increases as size of cog of the rear cassette utilized for gear ratio of the bicycle increases.

10. The bicycle of claim 1, wherein the derailleur includes a rotating member having a pulley mounted on each side thereof.

11. The bicycle of claim 10, wherein the rotating member and the pulleys are rotated based on the amount of chain growth.

12. The bicycle of claim 10, wherein the derailleur is secured to the swingarm in close proximity to the rear cassette.

13. The bicycle of claim 10, wherein the
derailleur further includes a spring;
the tension on the chain drive caused by increasing chain growth causes the rotating member and the pulleys to rotate in a first direction to increase the driveline angle; and
the spring causes the rotating member and the pulleys to rotate in a second direction to provide appropriate tension to the chain drive and reduce the driveline angle when the chain growth decreases.

14. The bicycle of claim 1, further comprising an electric motor.

15. A rear suspension bicycle comprising
a frame including a front triangle and a swingarm;
a rear suspension pivot point between the front triangle and the swingarm; and
a drive train including a chain drive, a rear cassette having a plurality of cogs located at a rear wheel axis, a front chainring located at a crank axis, a routing pulley and a derailleur located in proximity to the rear cassette, wherein the chain drive traverses from the rear sprocket to the front chainring, from the front chainring to the tension pulley and from the routing pulley to the derailleur and from the derailleur back to the rear cassette, wherein the derailleur is to provide different driveline angles based on chain growth of the chain drive caused by the cog of the rear cassette selected and vertical rear wheel travel of the bicycle.

16. The bicycle of claim 15, wherein the routing pulley is located behind and above the front chainring and is to route an untensioned portion of the chain drive toward a tensioned portion of the chain drive in order to reduce chain growth in the chain drive.

17. The bicycle of claim 15, wherein the routing pulley is mounted to the front triangle.

18. The bicycle of claim 15, wherein a seat tube of the front triangle includes a bracket extending therefrom and the routing pulley is mounted to the bracket.

19. The bicycle of claim 15, wherein the driveline angle provided by the derailleur increases as the chain growth increases, wherein the chain growth increases as the vertical rear wheel travel increases and as size of cog of the rear cassette utilized for gear ratio of the bicycle increases.

20. The bicycle of claim 15, wherein
the derailleur includes a rotating member having a pulley mounted on each side thereof and a spring;
tension on the chain drive caused by increasing chain growth causes the rotating member and the pulleys to rotate in a first direction to increase the driveline angle; and
the spring causes the rotating member and the pulleys to rotate in a second direction to provide appropriate tension to the chain drive and reduce the driveline angle when the chain growth decreases.
